(19) United States
(12) Patent Application Publication
(10) Pub. No.: US 2008/0074055 A1
(43) Pub. Date: Mar. 27, 2008

(54) LAMP FLASH APPARATUS AND METHOD

(76) Inventors: Don Peterson, Boise, ID (US); David Aldo Navone, Stockton, CA (US)

Correspondence Address: ADAMS INTELLECTUAL PROPERTY LAW, P.A., Suite 2350 Charlotte Plaza, 201 South College Street, CHARLOTTE, NC, 28244, US

(21) Appl. No.: 11/534,522

(22) Filed: Sep. 22, 2006

(51) Int. Cl. H05B 37/00

(52) U.S. Cl. 315/241 P

(57) ABSTRACT

An apparatus for triggering a flash in a gas discharge lamp includes a power supply; a current limiter operatively connected between the power supply and the lamp to limit the current flowing through the lamp to a first preselected level; and a shunt path operatively connected between the power supply and the lamp to selectively increase the current flow through the lamp to a second level higher than the first level to produce a flash of increased brightness. Independently or in conjunction with the flash circuit, magnetic fields can be applied to the gas discharge lamp to increase electron path length in the plasma, increasing the optical output of the lamp.

### TECHNICAL FIELD AND BACKGROUND OF THE INVENTION

The present invention relates to gas discharge lamps, and more particularly to apparatus and methods used to flash a gas discharge lamp.

Though fluorescent and other gas discharge lamps are generally operated in a steady state mode, there are some instances where it is desirable to flash a lamp that is already on to momentarily provide increased light output. One such application is photography in the field of dermatology. By utilizing low level ultraviolet (UV) light, dermatologists can evaluate overall skin quality by detecting inconsistencies not apparent under normal light through the use of a light-tight skin analysis machine (SAM) lined with UV-A fluorescent lamps. Since it is desirable to capture a SAM image for future review, the machines can be equipped with conventional or digital cameras. Typical UV lamps do not put out enough UV radiation to cause interesting artifacts on and/or under the skin to fluoresce brightly enough to easily photograph.

It is known that lamps can be flashed by re-activating lamp filament heaters or starters to increase the lamp output; however, many fluorescent lamps do not use heaters. Also, the circuitry to re-heat the filaments is complex and difficult to implement. Re-heating the filaments may also damage the ballast and may require using larger and more expensive ballasts.

### SUMMARY OF THE INVENTION

Therefore, it is an object of the invention to flash a gas discharge lamp so as to temporarily increase its light output.

It is another object of the invention to flash a gas discharge lamp by momentarily permitting a higher current flow through the lamp.

It is another object of the invention to provide an effective electronic flash circuit having common, inexpensive, and uncomplicated circuit components.

These and other objects of the invention are achieved in one aspect of the invention by providing an electronic flash circuit for triggering a flash in a gas discharge lamp, the electronic flash circuit including: a power supply; a current limiter operatively connected between the power supply and the lamp to limit the current flowing through the lamp to a first preselected level; and a shunting means operatively connected between the power supply and the lamp for selectively increasing the current flow through the lamp to a second level higher than the first level to produce a flash of increased brightness.

According to another aspect of the invention, the shunting means defines a shunt path selectively connectable in parallel with the current limiter to direct part of the current from the power supply to the lamp around the current limiter.

According to another aspect of the invention, the shunt path includes: an impedance; and a switch operatively connected in series with the impedance and adapted to close in response to an activation means.

According to another aspect of the invention, the shunting means includes a switching element adapted to selectively disconnect the current limiter from the electronic flash circuit by directing the current from the power supply to the lamp through a circuit path selectively connectable to the circuit.

According to another aspect of the invention, the shunt path includes an impedance for limiting the current flowing through the lamp.

According to another aspect of the invention, the activation means is a hot shoe of a camera operatively connected to the switch.

According to another aspect of the invention, the power supply provides an alternating current.

According to another aspect of the invention, a synchronization element is operatively connected to the shunting means and adapted to trigger the flash of the lamp at a preselected voltage or current level of the alternating current flow from the power supply.

According to another aspect of the invention, the gas discharge lamp is a fluorescent lamp adapted to emit ultraviolet light.

According to another aspect of the invention, the second current level is at least about 25 times the first current level.

According to another aspect of the invention, the shunting means is adapted to increase the optical power output of the lamp by a factor of at least about 2.

According to another aspect of the invention, the current limiter is a ballast.

According to another aspect of the invention, the ballast is adapted to accumulate stored energy from the current flowing therethrough and to release the stored energy to increase the current flow through the lamp during the flash.

According to another aspect of the invention, a starter switch is operatively connected in series with the current limiter and operatively connected across the lamp.

According to another aspect of the invention, an electronic flash circuit for triggering a flash in a gas discharge lamp is provided, the electronic flash circuit including: a power supply; a current limiter operatively connected between the power supply and the lamp to limit the current flowing through the lamp to a first preselected level; and a shunt path operatively connected between the power supply and the lamp to selectively permit current flow through the lamp at a second level higher than the first level to produce a flash of increased brightness.

According to another aspect of the invention, a method for using an electronic flash circuit to flash a gas discharge lamp includes the steps of providing an electronic flash circuit having: a power supply; a current limiter operatively connected between the power supply and the lamp; and a shunt path operatively connected between the power supply and the lamp; illuminating the lamp with the current flowing through the lamp at a first preselected level; and selectively directing at least some current through the shunt path to increase the current flow through the lamp to a second level higher than the first level to produce a flash in the lamp of increased brightness.

According to another aspect of the invention, the shunt path is selectively connectable in parallel with the current limiter to direct part of the current from the power supply to the lamp around the current limiter.

According to another aspect of the invention, the electronic flash circuit further includes a switching element adapted to selectively disconnect the current limiter from the electronic flash circuit by directing the current from the power supply to the lamp through the shunt path.

According to another aspect of the invention, the electronic flash circuit further includes a synchronization element operatively connected to the shunt path and adapted to trigger the flash of the lamp at a preselected voltage or current level.

According to another aspect of the invention, a method for capturing an image of an object includes the steps of: illuminating the object with ultraviolet light from a gas discharge lamp at a preselected first level of intensity; flashing the lamp to a second level of intensity higher than the first level; and capturing an image on a camera while the lamp is illuminated at the second level of intensity.

According to another aspect of the invention, the camera is a digital camera.

According to another aspect of the invention, the camera contains film.

According to another aspect of the invention, an apparatus for creating a flash in a gas discharge lamp includes magnetic field means for selectively generating a magnetic field passing through the lamp, so as to lengthen the path of electrons and ions of the plasma within the lamp from a nominal path length, thereby increasing the energy radiated per unit length of the lamp.

According to another aspect of the invention, the magnetic field means comprise at least one electromagnet or permanent magnet disposed adjacent the lamp.

According to another aspect of the invention, the apparatus further includes an activation means adapted to, in response to a user input, operate the magnetic field means to generate a magnetic field passing through the lamp by means of a pulsed electromagnet.

### BRIEF DESCRIPTION OF THE DRAWINGS

The subject matter that is regarded as the invention may be best understood by reference to the following description taken in conjunction with the accompanying drawing figures in which:

FIG. 1 is a schematic diagram illustrating an exemplary flash circuit constructed according to the invention;

FIG. 2 is a schematic diagram illustrating an alternative flash circuit;

FIG. 3 is a schematic diagram illustrating another alternative flash circuit;

FIG. 4 is a diagram illustrating the operation of the flash circuit of FIG. 3;

FIG. 5 is a schematic diagram illustrating another alternative flash circuit using magnetic fields;

FIG. 6 is a side view of an electromagnet disposed near a gas discharge lamp;

FIG. 7 is a side view of a permanent magnet disposed near a gas discharge lamp;

FIG. 8 is a rear perspective view of a skin analysis machine incorporating the flash circuit of the present invention; and

FIG. 9 is a perspective view of the interior of the machine of FIG. 8.

### DESCRIPTION OF THE PREFERRED EMBODIMENTS AND BEST MODE

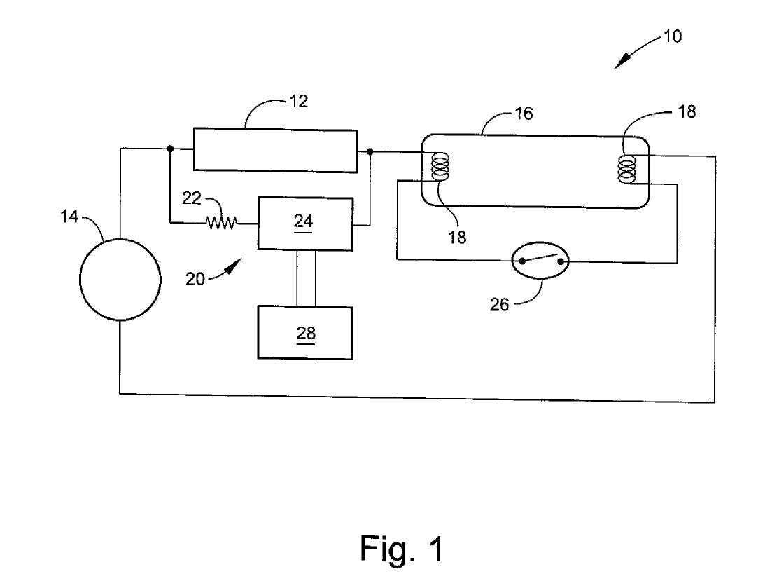

Referring to the drawings wherein identical reference numerals denote the same elements throughout the various views, FIG. 1 represents an electronic flash circuit shown generally at reference numeral 10. The circuit 10 includes a current limiter 12 connected between a power supply 14 and a lamp 16. As illustrated, the power supply 14 is 120 Volts 60 Hertz alternating current (AC) line voltage, but any power supply compatible with the lamp 16, including batteries or another DC source may be used. In normal operation, the current limiter 12 may be any type of current limiting device that limits current flow through the lamp 16 to a preselected level. Non-limiting examples of current limiting devices include “iron” or electronic ballasts, inductors, resistors, and capacitors. As illustrated in FIG. 1, current limiter 12 is a known type of ballast having inductive properties, which not only limits the absolute current flow, but also limits the rate of change of current. The lamp 16 shown is a fluorescent lamp having filaments 18, but any type of gas discharge lamp or arc lamp may be used in circuit 10.

A shunting means 20 is connected between the power supply 14 and the lamp 16. As illustrated in FIG. 1, the shunting means 20 includes a series-connected resistor 22 and a switch 24 connected in parallel with the current limiter 12. However, the shunting means 20 can be any combination of circuit elements operable to selectively direct at least some current flow to the lamp 16 independent of the current limiter 12 to lower the total circuit path impedance in series with the lamp 16 and produce an increased current flow through the lamp 16. The shunting means 20 may include any combination of mechanical, electronic, or solid state devices. While the shunting means 20 is illustrated as being connected to a “hot” leg of the circuit 10, it could also be connected to the neutral leg.

Also in FIG. 1, the circuit 10 includes a starter switch 26 connected in series with the current limiter 12 and connected across the lamp filaments 18. As illustrated, the starter switch 26 is a thermal starter switch; however, other types of starters are known and may be incorporated with the current limiter 12 into a single device (i.e. in an electronic ballast).

The switch 24 is operably connected to an activation means 28 adapted to operate the switch 24. As illustrated, the activation means 28 is a standard “hot shoe” of a camera (not shown) operable to cause the switch 24 to close when the camera shutter is tripped. The activation means 28 may be any mechanical or electronic device capable of actuating or controlling the switch 24.

The circuit 10 operates as follows. After an arc is struck and the lamp 16 is illuminated in a conventional manner, the circuit 10 operates in a normal mode, i.e. at substantially a steady state. In this mode, the power supply 14 supplies current that flows through the current limiter 12, the filaments 18, and across the arc (not illustrated) in the lamp 16, before returning to the power supply 14. In order to regulate current flow and prevent damage to the filaments 18 or the lamp 16, the current limiter 12 limits the current flowing through the lamp 16 to a first preselected level.

When a flash of increased brightness is desired, the activation means 28 is used to close the switch 24, which creates a parallel “shunt path” through the shunting means 20. This shunt path allows some of the current flow through the circuit 10 to be diverted away from the current limiter 12, going instead through the resistor 22 and the switch 24 before flowing through the lamp 16. Though it is not required, directing current around the current limiter 12 and through the shunting means 20 can result in the release of stored energy from the current limiter 12 (if capable of storing energy) which contributes to a yet higher current flow through the lamp 16. In any case, the use of the shunting means 20 lowers the impedance of the overall circuit path in series with the lamp 16 and increases the current flow through the lamp 16 to a second level higher than the first current level to produce a flash of increased brightness. The resistor 22 permits a rapid current rise through the lamp 16 to produce the flash, but is selected to limit the current sufficiently to prevent damage to the lamp 16. Any single active or passive circuit element, or combination of such circuit elements that provides a selected impedance may be substituted for the resistor 22 to limit current flow through the shunt path to a safe value. This element or combat ion of elements is referred to as an “impedance”.

After producing a flash of the desired duration, the shunting means 20 may reopen, which redirects current flow through the current limiter 12. As such, current flow through the lamp returns to its first preselected level.

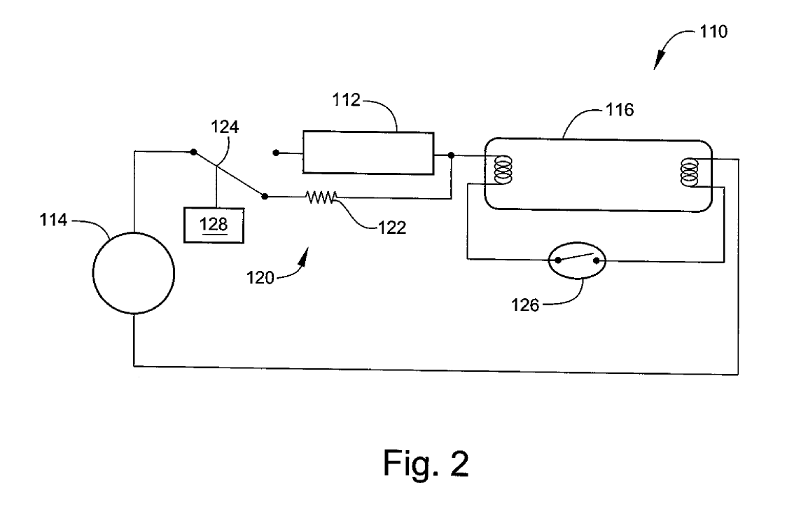

FIG. 2 depicts an alternative electronic flash circuit 110. The flash circuit 110 is substantially identical in configuration with the circuit 10 shown in FIG. 1, and includes a power supply 114, current limiter 112, lamp 116, starter switch 126, and shunting means 120 including resistor (or other impedance) 122, the difference being in the shunting means 120. The shunting means 120 includes a switching element 124 for diverting current flow around the current limiter 112 and through resistor 122 in order to lower the overall impedance of the circuit path operably connected in series with the lamp 116. The resistor 122 (or other suitable impedance) permits a rapid current rise through the lamp 116, while limiting the current sufficiently to prevent damage to the lamp 116. As illustrated, switching element 124 is a “make-before-break” switch operable to make the circuit through the shunting means 120 before breaking the circuit through the current limiter 112. However, switching element 124 can be any circuit component that diverts at least some current around or away from the current limiter 112 and through the shunting means 120.

The circuit 110 operates as follows. When the lamp 116 is illuminated, the power supply 114 supplies current to the circuit 110 and current flows through the current limiter 112 and across the lamp filaments 118 as an arc at a first preselected level before returning to the power supply 114. In order to flash the lamp 116, activation means 128 actuates or otherwise controls the switching element 124 to open the circuit through the current limiter 112 shortly after making a shunt path through the shunting means 120. By using a “make-before-break” configuration, the circuit 110 is not completely broken and current always flows across the lamp filaments 118 to keep the lamp 116 illuminated. Once the operable connection between the switching element 124 and the current limiter 112 is broken, the current flow through the new circuit path is only limited by the illustrated resistor 122. Thus, a current flows at a second level higher than the first level across the lamp filaments 118 to produce a flash of increased brightness in the lamp 116.

After producing a flash, the switching element 124 may reconnect current limiter 112 shortly after breaking connection with the shunting means 120, thereby redirecting current flow through the current limiter 112. As such, the current flow through the lamp 116 returns to the first level.

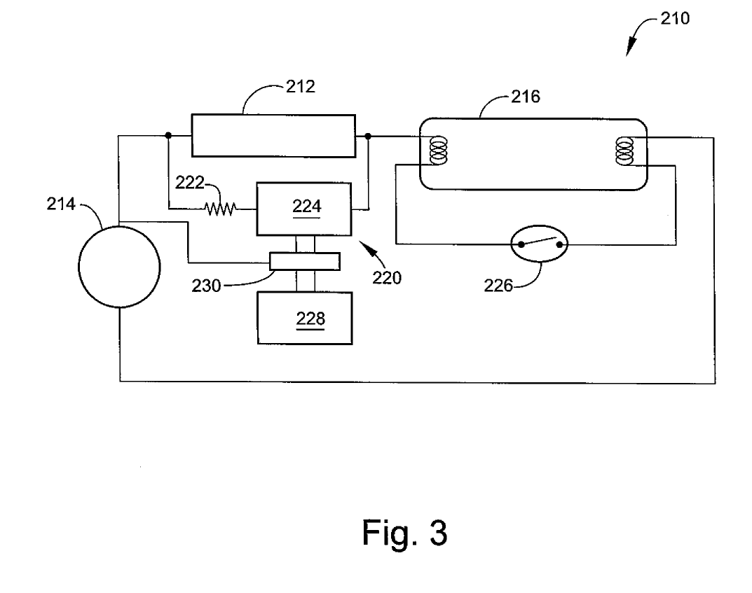

FIG. 3 illustrates another alternative flash circuit 210. The flash circuit 210 is substantially identical in configuration with the circuit 10 shown in FIG. 1, and includes a power supply 214, current limiter 212, lamp 216, starter switch 226, and shunting means 220 including resistor (or other suitable impedance) 222 and switch 224 triggered by activation means 228. The circuit 210 includes a synchronization element 230 operatively connected to the shunting means 220 and to the power supply 214. In this illustration, the power supply 214 provides 120 Volts 60 Hertz AC line voltage. The synchronization element 230 is adapted to trigger the flash of the lamp 216 at a preselected instantaneous value of a parameter of the alternating current from the power supply 214 (e.g. voltage, current, phase angle, or other suitable parameter).

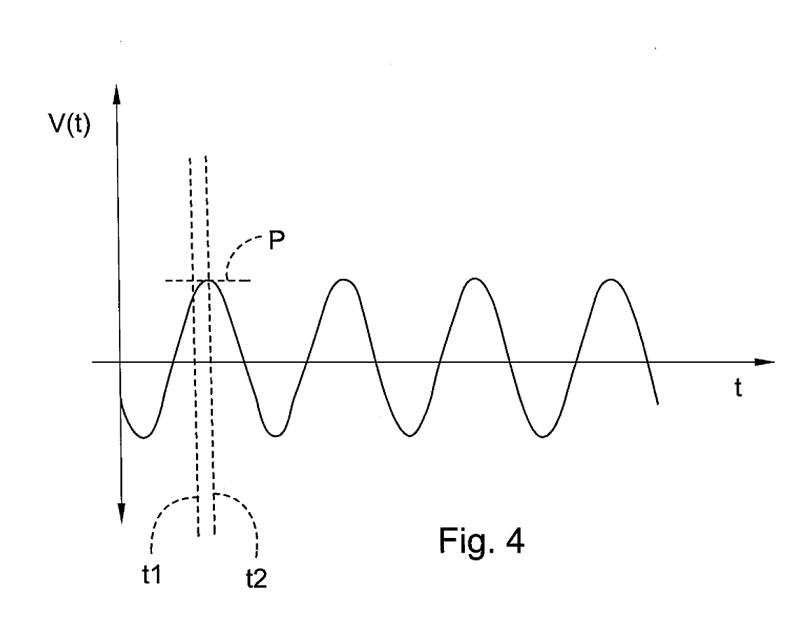

FIG. 4, which is plot of the power supply voltage vs. time, illustrates this process. For example, the activation means 228 may be triggered at an arbitrary time t1. This does not necessarily correspond to any particular instantaneous voltage and consequently, the intensity of the resulting flash would vary. Accordingly, the synchronization element 230 is effective to determine the state of the selected parameter and to trigger the shunting means 220 only when that parameter meets a preselected condition. For example, it may be desired to trigger the flash when the voltage is at a peak “P”, in which case the shunting means 220 would be triggered at time t2, slightly after t1. The synchronization element 230 can thus be used to maximize the brightness produced from the flash of the lamp 216. Components suitable for use as the synchronization element include, for example, diacs and triacs.

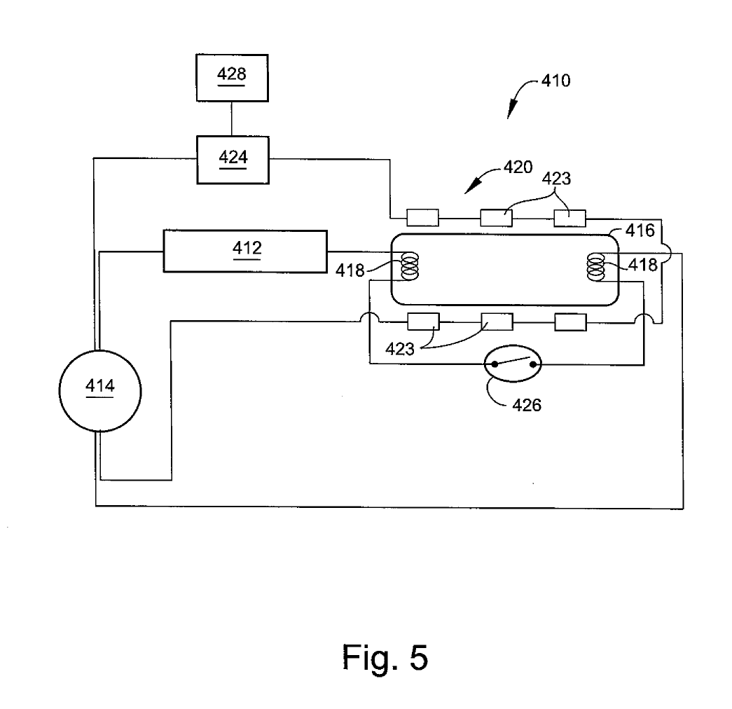

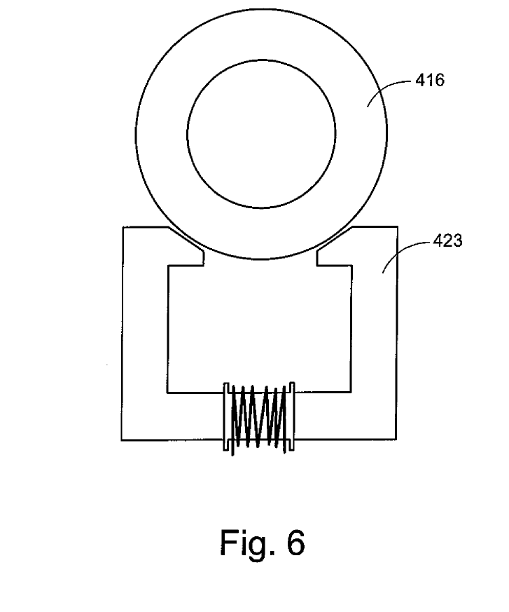

FIGS. 5 and 6 depict an alternative electronic flash circuit 410. The flash circuit 410 includes a power supply 414, current limiter 412, lamp 416 with opposed filaments 418, starter switch 426, and magnetic field generating means 420. A switching element 424 (such as a relay or solid state switch) controls the operation of the magnetic field generating means 420. The switching element 424 is operably connected to an activation means 428, similar to the activation means 28 described above and adapted to operate the switching element 424.

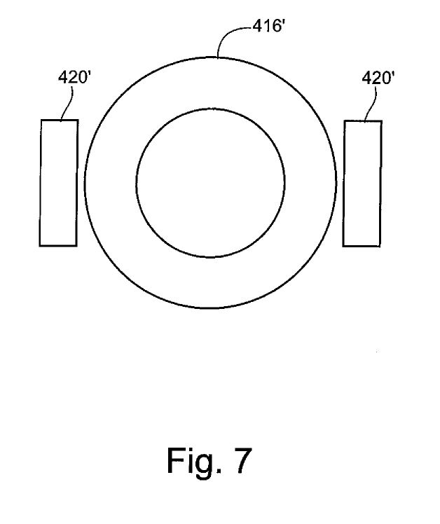

The magnetic field generating means 420 may be any device suitable for producing a static or dynamic magnetic field passing through the lamp 416 in order to lengthen the path of electrons and ions of the plasma within the lamp 416. In the illustrated example, the magnetic field generating means 420 comprises one or more electromagnets 423 positioned along the length of the lamp 416; however, permanent magnets could also be used, For example, FIG. 7 illustrates a lamp 416′ with a pair of fixed permanent magnets 420′ mounted adjacent thereto (in this case, switching element 424 would not be required).

The circuit 410 in FIG. 5 operates as follows. When the lamp 416 is illuminated, the power supply 414 supplies current to the circuit 410 and current flows through the current limiter 412 and across the lamp filaments 418 as an arc at a first preselected level along a nominal path (e.g. a straight line connecting the filaments 418) before returning to the power supply 414. In order to flash the lamp 416, activation means 428 actuates or otherwise controls the switching element 424 to operate the magnetic field generating means 420 (for example, by turning on the electromagnets 423). This increases the length of the plasma path between the extremities of the lamp 416. Rather than the normal straight line, the plasma path may “zig-zag” back and forth inside the lamp 416 (depending on the physical configuration of the magnetic field generation means 420), thereby increasing the amount of light per unit length. This produces a flash of increased brightness in the lamp 416. It is also possible to use the magnetic field generation means 420 in combination with the electronic flash circuit described above. If permanent magnets are used, the output of the lamp 416 is increased whenever it is in operation.

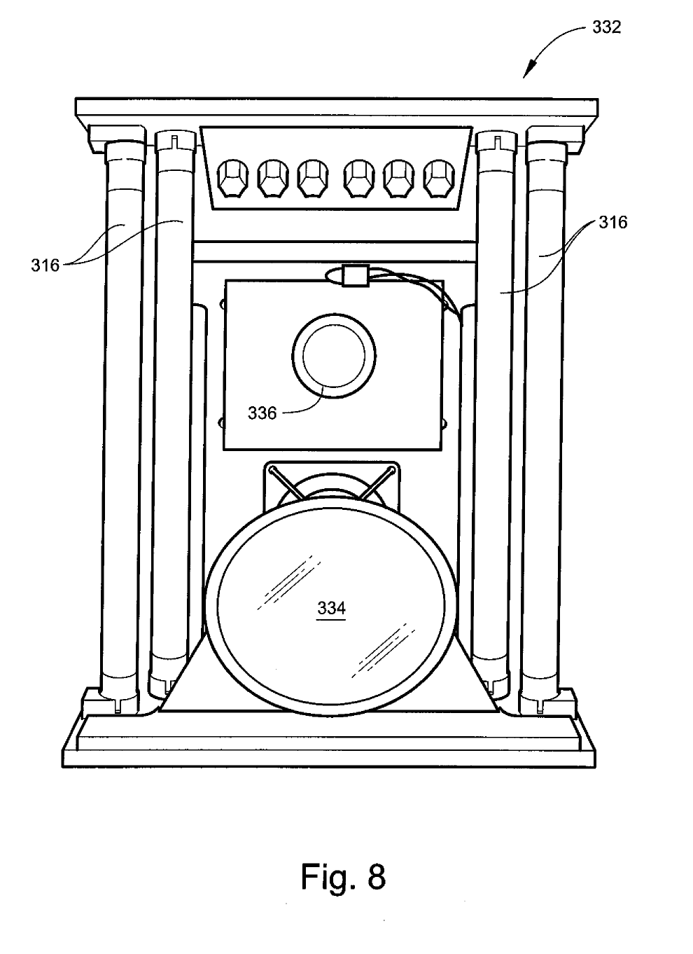

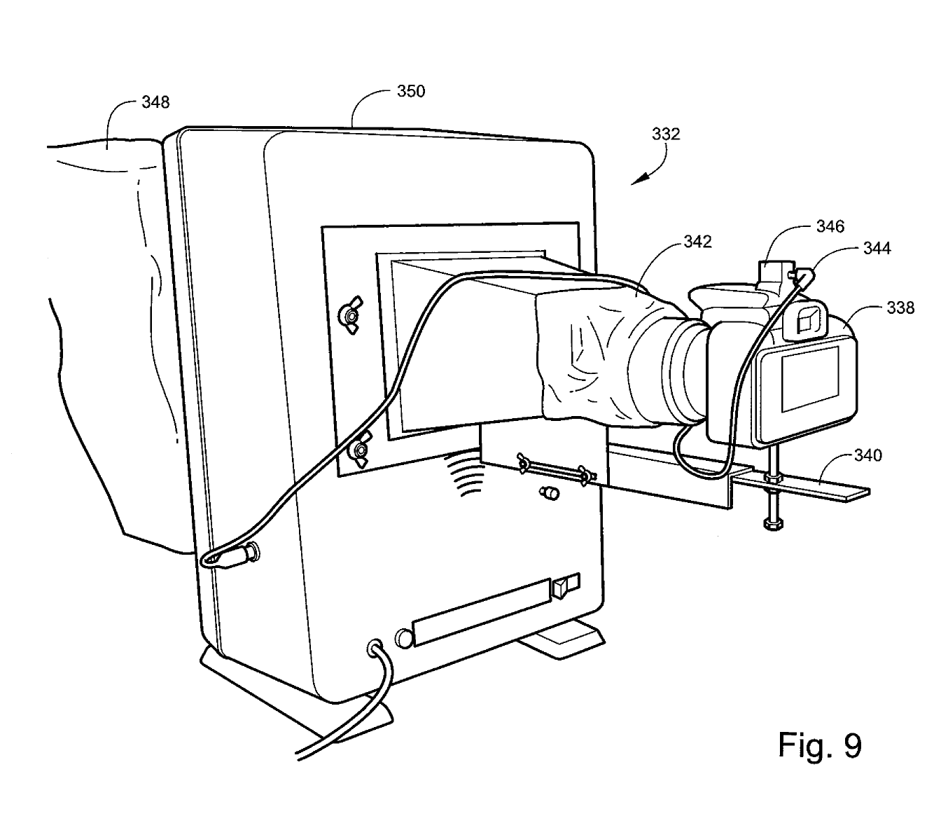

FIGS. 8 and 9 show internal and perspective views, respectively, of an exemplary skin analysis machine 332 which utilizes a flash circuit as described above. One or more lamps 316 are placed around an adjustable mirror 334 and an aperture 336 through which a camera 338 can capture the image. The camera 338 may be a film or digital camera, and is carried by an adjustable support member 340 with its lens inserted into a light tight sleeve 342. A cord 344 connects a hot shoe 346 of the camera to the shunting means (not shown) of the electronic flash circuit. A light tight hood 348 is attached to the machine housing 350 in order to provide a light tight envelope sufficient for quality photography. The operating components of the flash circuit are contained internally in the machine 332 and are not visible. One example machine 332 incorporates uses a set of F10T8.BLB UV-A fluorescent bulbs, a 33 Ohm ballast (as the current limiter), and a 50 Ohm resistor rated at 2 Watts for shunting across the ballast, resulting in a steady state current of approximately 0.2A RMS per bulb on 120VAC supply current. Shunting the ballast as described above results in a total circuit resistance of about 20 Ohms, and the resulting current surge through the lamp 16 is about 5A to about 10A RMS per bulb (or about 25 to 50 times the steady state current flow). The UV light power output of the lamps 316 is approximately doubled. As an alternative to, or in addition to the flash circuit, magnetic fields as described above may be used to generate or enhance a flash as well. Permanent magnets in experiments have been used to more than double the UV light power output of the magnetically-enhanced section of a lamp.

In use, a patient's head or other body part of interest is placed inside the light tight hood 348, and the mirror 334 is adjusted to maximize image quality and size. After initially illuminating the lamps 316 and allowing the current flowing therein to reach a first preselected level, the lamps 316 are flashed by sending a triggering signal to the flash circuit through the hot shoe 346 shortly before the camera 338 shutter is tripped to capture the image. The resulting high-intensity flash provides an increased UV flux which causes artifacts in, on, and under the skin to fluoresce. The resulting illumination lies in the visible spectrum and allows a high quality image of the patient's face or other body part to be captured by the camera 338. The image can be used to evaluate skin health or detect skin inconsistencies or disease.

The foregoing has described a lamp flash apparatus and method and a skin analysis machine incorporating the apparatus. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

What is claimed is:

1. An electronic flash circuit for triggering a flash in a gas discharge lamp, the electronic flash circuit comprising:
a) a power supply;
b) a current limiter operatively connected between the power supply and the lamp to limit the current flowing through the lamp to a first preselected level; and
c) a shunting means operatively connected between the power supply and the lamp for selectively increasing the current flow through the lamp to a second level higher than the first level to produce a flash of increased brightness.

2. The electronic flash circuit according to claim 1, wherein the shunting means defines a shunt path selectively connectable in parallel with the current limiter to direct part of the current from the power supply to the lamp around the current limiter.

3. The electronic flash circuit according to claim 2, wherein the shunt path includes:
a) an impedance; and
b) a switch operatively connected in series with the impedance and adapted to close in response to an activation means.

4. The electronic flash circuit according to claim 1, wherein the shunting means includes a switching element adapted to selectively disconnect the current limiter from the electronic flash circuit by directing the current from the power supply to the lamp through a circuit path selectively connectable to the circuit.

5. The electronic flash circuit according to claim 4, wherein the shunt path includes an impedance for limiting the current flowing through the lamp.

6. The electronic flash circuit according to claim 3, wherein the activation means is a hot shoe of a camera operatively connected to the switch.

7. The electronic flash circuit according to claim 4, further including an activation means adapted to operate the switching element to direct current through the shunt path.

8. The electronic flash circuit according to claim 1, wherein the power supply provides an alternating current.

9. The electronic flash circuit according to claim 8, further including a synchronization element operatively connected to the shunting means and adapted to trigger the flash of the lamp at a preselected voltage or current level of the alternating current flow from the power supply.

10. The electronic flash circuit according to claim 1, wherein the gas discharge lamp is a fluorescent lamp adapted to emit ultraviolet light.

11. The electronic flash circuit according to claim 1, wherein the second current level is at least about 25 times the first current level.

12. The electronic flash circuit according to claim 1, wherein the shunting means is adapted to increase the optical power output of the lamp by a factor of at least about 2.

13. The electronic flash circuit according to claim 1, wherein the current limiter is a ballast.

14. The electronic flash circuit according to claim 13, wherein the ballast is adapted to accumulate stored energy from the current flowing therethrough and to release the stored energy to increase the current flow through the lamp during the flash.

15. The electronic flash circuit according to claim 1, wherein a starter switch is operatively connected in series with the current limiter and operatively connected across the lamp.

16. An electronic flash circuit for triggering a flash in a gas discharge lamp, the electronic flash circuit comprising:
a) a power supply;
b) a current limiter operatively connected between the power supply and the lamp to limit the current flowing through the lamp to a first preselected level; and
c) a shunt path operatively connected between the power supply and the lamp to selectively permit current flow through the lamp at a second level higher than the first level to produce a flash of increased brightness.

17. The electronic flash circuit according to claim 16, wherein the shunt path is selectively connectable in parallel with the current limiter to direct part of the current from the power supply to the lamp around the current limiter.

18. The electronic flash circuit according to claim 17, wherein the shunt path includes:
a) an impedance; and
b) a switch operatively connected in series with the impedance and adapted to close in response to an activation means.

19. The electronic flash circuit according to claim 16, further including a switching element adapted to selectively disconnect the current limiter from the electronic flash circuit by directing the current from the power supply to the lamp through the shunt path.

20. The electronic flash circuit according to claim 19, wherein the shunt path includes an impedance for limiting the current flowing through the lamp.

21. The electronic flash circuit according to claim 18, wherein the activation means is a hot shoe of a camera operatively connected to the switch.

22. The electronic flash circuit according to claim 19, further including an activation means adapted to operate the switching element to direct current through the shunt path.

23. The electronic flash circuit according to claim 16, wherein the power supply provides an alternating current.

24. The electronic flash circuit according to claim 23, further including a synchronization element operatively connected to the shunt path and adapted to trigger the flash of the lamp at a preselected voltage or current level of the alternating current from the power supply.

25. The electronic flash circuit according to claim 16, wherein the gas discharge lamp is a fluorescent lamp adapted to emit ultraviolet light.

26. The electronic flash circuit according to claim 16, wherein the second current level is at least about 25 times the first current level.

27. The electronic flash circuit according to claim 16, wherein the shunt path is adapted to increase the optical power output of the lamp by a factor of at least about 2.

28. The electronic flash circuit according to claim 16, wherein the current limiter is a ballast.

29. The electronic flash circuit according to claim 28, wherein the ballast is adapted to accumulate stored energy from the current flowing therethrough and to release the stored energy to increase the current flow through the lamp during the flash.

30. The electronic flash circuit according to claim 16, wherein a starter switch is operatively connected in series with the current limiter and operatively connected across the lamp.

31. A method for using an electronic flash circuit to flash a gas discharge lamp, the method comprising the steps of:
a) providing an electronic flash circuit having:
i) a power supply;
ii) a current limiter operatively connected between the power supply and the lamp; and
iii) a shunt path operatively connected between the power supply and the lamp;
b) illuminating the lamp with the current flowing through the lamp at a first preselected level;
c) selectively directing at least some current through the shunt path to increase the current flow through the lamp to a second level higher than the first level to produce a flash in the lamp of increased brightness.

32. The method according to claim 31, wherein the shunt path is selectively connectable in parallel with the current limiter to direct part of the current from the power supply to the lamp around the current limiter.

33. The method according to claim 31, wherein the electronic flash circuit further includes a switching element adapted to selectively disconnect the current limiter from the electronic flash circuit by directing the current from the power supply to the lamp through the shunt path.

34. The method according to claim 31, wherein the electronic flash circuit further includes a synchronization element operatively connected to the shunt path and adapted to trigger the flash of the lamp at a preselected voltage or current level.

35. A method for capturing an image of an object, comprising the steps of:
a) illuminating the object with ultraviolet light from a gas discharge lamp at a preselected first level of intensity;
b) flashing the lamp to a second level of intensity higher than the first level; and
c) capturing an image on a camera while the lamp is illuminated at the second level of intensity.

36. The method according to claim 35, wherein the camera is a digital camera.

37. The method according to claim 35, wherein the camera contains film.

38. The method according to claim 35, wherein the lamp is supplied with alternating current, and further including the step of flashing the lamp when the voltage or current flowing through lamp is at a preselected level.

39. An apparatus for creating a flash in a gas discharge lamp, comprising magnetic field means for selectively generating a magnetic field passing through the lamp, so as to lengthen the path of electrons and ions of a plasma within the lamp from a nominal path length, thereby increasing the optical energy radiated per unit length of the lamp.

40. The apparatus of claim 39, wherein the magnetic field means comprise at least one electromagnet disposed adjacent the lamp.

41. The apparatus of claim 39 wherein the magnetic field means comprises at least one permanent magnet disposed adjacent the lamp.

42. The apparatus of claim 39 further including an activation means adapted to, in response to a user input, operate the magnetic field means to generate a magnetic field passing through the lamp.
